(19) United States
(12) Patent Application Publication
(10) Pub. No.: US 2005/0071342 A1
(43) Pub. Date: Mar. 31, 2005

(54) Data processing for objects with unknown data structures

(75) Inventor: Jeffrey David Calusinski, West Chicago, IL (US)

Correspondence Address: IBM CORP (BLF), c/o BIGGERS & OHANIAN, LLP, 504 LAVACA STREET, SUITE 970, AUSTIN, TX, 78701-2856, US

(73) Assignee: INTERNATIONAL BUSINESS MACHINES CORPORATION, ARMONK, NY (US)

(21) Appl. No.: 10/671,199

(22) Filed: Sep. 25, 2003

(51) Int. Cl. G06F 7/00

(52) U.S. Cl. 707/100

(57) ABSTRACT

Data processing for objects with unknown data structures, including receiving a processing request for a business object having an unknown business object data structure, where data for the business object is stored in a persistent data store having an unknown persistent data structure, and the processing request includes a reference to the business object and a processing instruction. Embodiments typically also include: inferring the business object data structure from metadata describing the business object; inferring the persistent data structure from metadata describing the persistent data structure; validating the business object data structure with respect to the persistent data structure; creating a data object structured according to the persistent data structure; transforming data values from the business object to the data object; and applying the processing instruction, with the data object, to the persistent data store.

### BACKGROUND OF THE INVENTION

1. Field of the Invention

The field of the invention is data processing, or, more specifically, methods, systems, and products for data processing for objects with unknown data structures.

2. Description of Related Art

Objects are instances of object-oriented classes, complex data structures capable of containing data elements, other data structures, and member methods. Programmers develop classes for use in solving particular problems, so that the data structures in the classes, and objects instantiated from the classes, are fashioned appropriately for solving particular problems from the programmer's point of view. Such objects, fashioned for use in client application code, are referred to in this disclosure as “business objects.” Business objects upon instantiation often need data from databases or other persistent data stores. As business objects are used, their data values change, and there is often therefore a need to update the corresponding data in the persistent data store. The structure of the corresponding data in the persistent data store, its field names and data types, often is different from the structure of the business objects.

Persistent stores, such as database management systems, for example, typically support APIs (Application Programming Interfaces) for programmer to call in order to read or write data to or from the stores. In prior art, when a programmer needs to read or write data from a persistent store to or from a business object, the programmer must laboriously identify the corresponding data structure in the persistent data store, convert the data structure from the structure of the business object to the structure supported by the persistent store, and then write instructions in whatever special format is supported by the API for the persistent store. Often, for example, APIs for persistent data stores require or support some kind of SQL (Structured Query Language) for reading and writing data to and from the store. In such systems, the programmers must not only write code in a language that forms and manipulates their own application software, but must also write SQL for foreign data structures, with unfamiliar data names and types. This is a laborious and error-prone process.

Various adapter-type design patterns have been proposed in prior art to present a single interface to a client application programmer. All such patterns in prior art require that both data structures, the client business object and the structure of the persistent data store, be completely known to the adapter at the time when it is developed—so that the adapter can be programmed to transform data structures to and from the structure of the persistent data store. Later changes in either the business object structure or the structure of the persistent data store require corresponding changes in the adapter. For all these reasons, there remains a need for technical improvement in this field of art.

### SUMMARY OF THE INVENTION

Methods, systems, and products according to embodiments of the present invention generally provide persistence frameworks to administer data processing for business objects and persistent data stores, where the business object data structures and the data structures of the persistent data stores are entirely unknown to the persistence framework until the framework is called. When such a framework is invoked to read or write data between a business object and a persistent data store, the framework infers both data structures from metadata. In this way, neither data structure need be known when the framework is developed, and no changes in the framework are needed when changes are made in either the structure of the business object or the structure of the persistent data store.

More particularly, method, systems, and products are described for data processing for objects with unknown data structures, typically including receiving a processing request for a business object having an unknown business object data structure, where data for the business object is stored in a persistent data store having an unknown persistent data structure, and the processing request includes a reference to the business object and a processing instruction. Typical embodiments also include inferring the business object data structure from metadata describing the business object; inferring the persistent data structure from metadata describing the persistent data structure; validating the business object data structure with respect to the persistent data structure; creating a data object structured according to the persistent data structure; transforming data values from the business object to the data object; and applying the processing instruction, with the data object, to the persistent data store.

In many embodiments, a business object may be a Java object, and inferring the business object data structure from metadata describing the business object then is carried out through Java reflection. In many embodiments, a business object has a class name, and inferring the business object data structure from metadata describing the business object is carried out by inferring the business object data structure in dependence upon the class name of the business object.

In many embodiments, the persistent data store is a table in a database, and inferring the persistent data structure from metadata describing the persistent data structure comprises reading from metadata describing the database. In many embodiments, the persistent data store is a table in a database, and inferring the persistent data structure comprises identifying the table in dependence upon a class name of the business object. Validating the business object data structure with respect to the persistent data structure typically means determining that there exists a mapping from fields in the business object to fields in the persistent data store.

In many embodiments, a mapping comprises a one-to-one correspondence between field names in the business object and field names in the persistent data store. In other embodiments, a mapping comprises an algorithmically-inferred one-to-one correspondence between fields in the business object and fields in the persistent data store. In still further embodiments, a mapping comprises a correspondence, defined in a mapping data structure, between fields in the business object and fields in the persistent data store. Transforming data values from the business object to the data object typically includes transforming the data values according to the mapping from fields in the business object to fields in the persistent data store.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of a system for data processing for objects with unknown data structures.

FIG. 2 sets forth a class relationship diagram illustrating an exemplary persistence framework.

FIG. 3 sets forth a data flow diagram illustrating an exemplary method of data processing for objects with unknown data structures.

### DETAILED DESCRIPTION OF EXEMPLARY EMBODIMENTS

### Introduction

The present invention is described to a large extent in this specification in terms of methods for data processing for objects with unknown data structures. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Data Processing for Objects with Unknown Data Structures

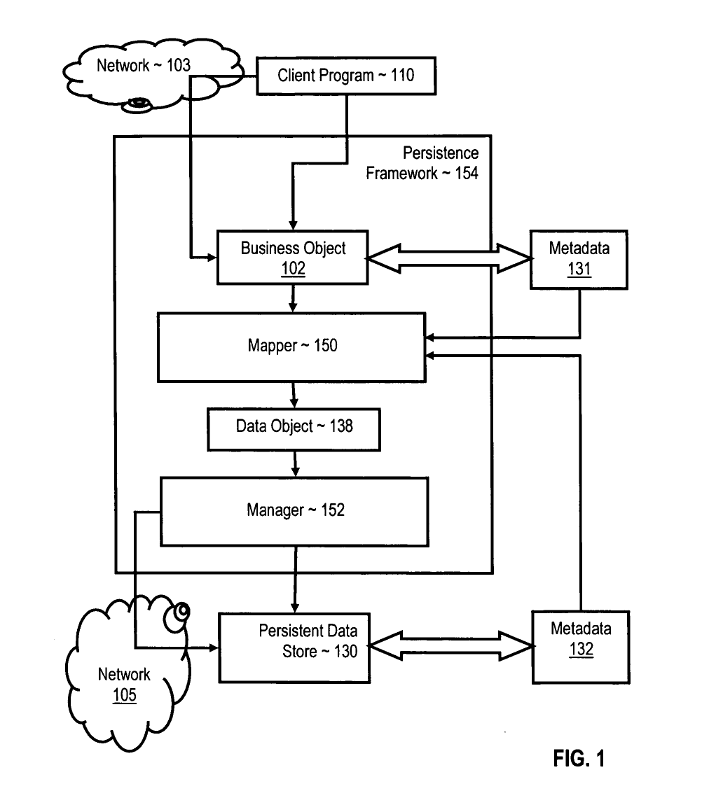

Methods, systems, and products for data processing for objects with unknown data structures are now explained with respect to the drawings, beginning with FIG. 1. FIG. 1 sets forth a block diagram of a system for data processing for objects with unknown data structures. The system of FIG. 1 includes a persistence framework (154). A persistence framework is a kind of application program built of cooperating classes. The persistence framework represents a data processing tool for use by other programs. The other programs that may use such a tool as an aid in data processing are referred to throughout this specification as “client programs” or “client applications.” In this example, the persistence framework (154) includes a mapper (150) and a data store manager (152). The mapper (150) is an object programmed to:
infer from metadata (131) the data structure of a business object (102);
infer from metadata (132) data structure of a persistent data store (130);
validate the business object data structure with respect to the data structure of the persistent data store;
create a data object (138) structured according to the data structure of the persistent data store (130); and
transform data values from the business object (102) to the data object.

Metadata (131) is metadata describing the data structure of a business object. Such metadata may be represented, for example, by reflection classes in a JVM (Java Virtual Machine.) Metadata (132) is metadata describing the data structure of a persistent data store. Such metadata may be represented, for example, by a data dictionary of a database management system describing the tables, fields, and data types in a database.

Data store manager (152) is an object programmed to provide an interface between the persistence framework (154) and a persistent data store (130). Data store manager is programmed to apply a processing instruction to the persistent data store, using the data object (138). The data store manager (152) never knows the data structure of the business object. By the time the data object (138) arrives in the data store manager (152), mapper (150) has provided within it table names and field names known to the persistent data store (130) and data types as used in the persistent data store (130). That is, to the extent that data types are different between the business object and the persistent data store, to the extent that integers need to be converted to floats or character arrays need to be converted to strings, and so on, such conversions are already done by the time the data store manager is invoked. Hence the use of these terms throughout this specification: A “business object” is an object having a data structure known within a client program. A “data object” is an object containing a data structure, data element names and types of data values, known within a persistent data store. Both data structures, the business object data structure and the persistent data structure, are unknown to the persistence framework when it is invoked; they are inferred at run time. Moreover, even after the persistence framework is invoked, the pertinent data structure remain unknown to it in the sense that the framework stores no descriptions of such data structures within the framework itself.

There is no limitation regarding the location of elements of systems according to embodiment of the present invention. The persistence framework and the client program may both be software programs installed and operating upon the same computer, or the client program may invoke the persistence framework, or elements of it, remotely across a network (103). Similarly, a persistent data store (130) may be located on the same computer with the persistence framework or on the same computer with a client program or both, or the persistent data store may be accessed remotely by a data store manager (152) across a network (105). Moreover, elements of the persistence framework itself may be located on different computers and access or invoke one another remotely across networks. In fact, any data communications arrangement among elements of such a system as will occur to those of skill in the art is well within the scope of the present invention.

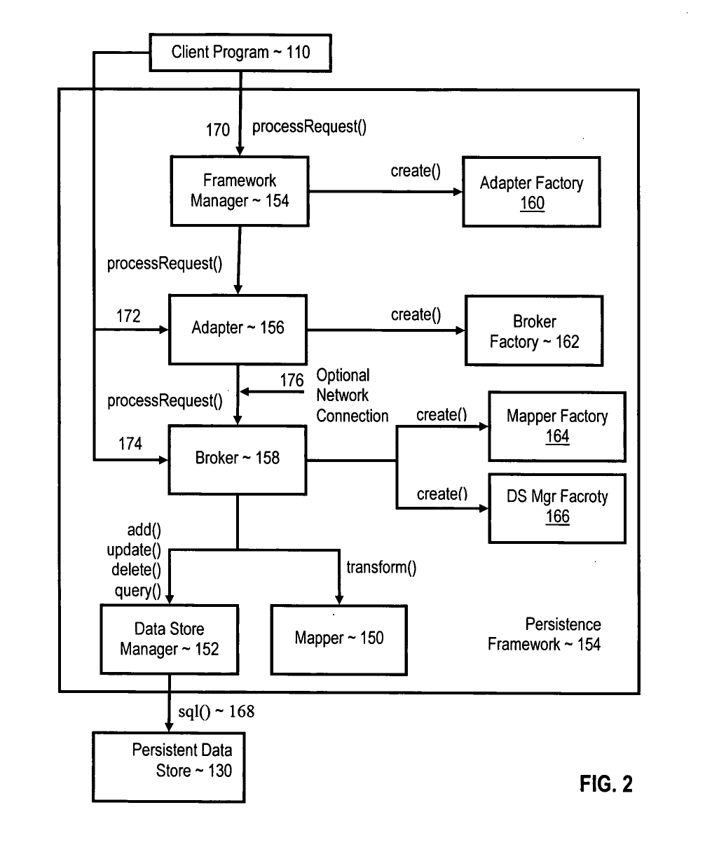

By way of further explanation, FIG. 2 sets forth a class relationship diagram illustrating an exemplary persistence framework, a set of exemplary cooperating classes that provide data processing for objects with unknown data structures. The exemplary persistence framework of FIG. 2 includes a mapper (150) and a data store manager (152), each of which functions as described above. In addition, the exemplary persistence framework of FIG. 2 includes a broker object (158). The broker object (158) provides flexibility of service from the framework by supporting multiple mapper classes instantiated according to the complexity of a particular mapping task.

A simple mapping task is one in which the data elements in a business object have exactly the same names and data types as their corresponding fields in a persistent data store. Another example of a simple mapping task is one in which fields in the business object and corresponding fields in a persistent data store have the same data types, integer, string, array, and so on, but there is no direct one-to-one correspondence between the field names, although the mapping from business object field names to field names in the persistent data store may be accomplished with simple algorithms, such as, for example, the use of synonyms. In such a mapping, the following names may be considered synonyms: Last_Name, Last_name, LastName, lastName, Lname, LName, L_name, L_Name, LN, In, L_N, and so on, so that a mapping is identified when a field in a business object has any of these names and a field in a persistent data store has any other name from this list.

An example of a more complex mapping task is one in which data types do not correspond or there is no easily inferred correspondence among field names. In such mappings, at least some fields may require data type conversions, from integer to float or character array to string, for example. Alternatively, some fields may have no direct correspondence at all, such as, for example, fields whose values are the result of calculations performed upon values from other fields, differences, sums, multiplications, and so on.

Broker (158) obtains from mapper factory (164) references to mappers (150) capable of different complexities of mapping. Given the class name of a business object, a create( ) method in mapper factory (164) may read from a table, an XML document, or other data store, a class name of a mapper capable of performing the needed transformation for a particular business object. A reference to the business object may be provided in the broker's call to the create( ) method:
Mapper myMapper=MapperFactory.create(object someBusinessObject);

The class name of the business object may be obtained from the business object itself, as from a field established for that purpose by the client programmer. Alternatively, in the case of a Java business object, for another example, the class name may be obtained by Java reflection. For each Java class, including the class from which any Java business object is instantiated, each Java runtime environment maintains a reflection class object that contains descriptive information about the class. A reflection class object represents, or “reflects,” the class. With the standard Java reflection API, MapperFactory.create( )can invoke methods on a reflection class object which return objects describing the business object's member methods and data fields. MapperFactory.create( ) then can use these objects to get information about the corresponding methods and fields defined in the business object. The following pseudocode segment, for example, places the name of the business object “someBusinessObject” in String s:

```
import java.lang.reflect.*;
mapper create(object someBusinessObject)
{
  Class c = someBusinessObject.getClass( );
  String s = c.getName( );
  String mapperClassName = lookupMapperClassName(s);
  Class mapperClassDefinition =
  Class.forName(String mapperClassName);
  Mapper aMapper = mapperClassDefinition.newInstance( );
  return aMapper;
}
```

That is, for a business object instantiated from a class named “someBusinessObject,” this example code segment places the string “someBusinessObject” in String s. The create( ) method, now armed with the class name, can look up the class name of an appropriate mapper in an XML document, such as, for example, the following:

```
<Descriptor>
  <businessObjectClassName> someBusinessObject
    <mapperClassName> simpleMapper
    </mapperClassName>
  </businessObjectClassName>
  <businessObjectClassName> someOtherBusinessObject
    <mapperClassName> complexMapper
    </mapperClassName>
  </businessObjectClassName>
  ...
  ...
</Descriptor>
```

This example XML document with root element tagged <Descriptor> has elements tagged as <businessObjectClassName> that organize subelements according to business object class names. In this example, one business object class name “someBusinessObject” has an associated mapper class named “simpleMapper,” identified by a subelement tagged as <mapperClassName>. Similarly, another business object class name “someOtherBusinessObject” has an associated mapper class named “complexMapper.” The fact that only two <businessObjectClassName> elements are illustrated here is for convenience of explanation, not for limitation. In fact, many <businessObjectClassName> elements, or their equivalents, are used in practical implementations.

Given a business object class name of “someBusinessObject,” MapperFactory.create( ) may proceed by retrieving the mapper class name “simpleMapper” from the example XML document shown above. In terms of the exemplary MapperFactory.create( ) method set forth above, the call:
String mapperClassName=lookupMapperClassName(s);
   is a call to a method programmed to lookup, in an XML document like the one shown above, a mapper class name in dependence upon the business object class name stored in String s. MapperFactory.create( ) then proceeds in the next three lines:
Class mapperClassDefinition=Class.forName(String mapperClassName);
Mapper aMapper=mapperClassDefinition.newInstance( );
return aMapper;
   to use Java reflection to obtain a reflection class definition for the mapper class whose name is stored in String mapperClassName, instantiate a new mapper object of that class, and return a reference to the new mapper object.

Broker (158) also obtains from a data store manager factory (166) a reference to a data store manager object (152). The exemplary XML document may be extended as follows:

```
<Descriptor>
  <businessObjectClassName> someBusinessObject
    <mapperClassName> simpleMapper
    </mapperClassName>
    <dataStoreMgrClassName> someDSManager
    </dataStoreMgrClassName>
  </businessObjectClassName>
  <businessObjectClassName> someOtherBusinessObject
    <mapperClassName> complexMapper
    </mapperClassName>
    <dataStoreMgrClassName> anotherDSManager
    </dataStoreMgrClassName>
  </businessObjectClassName>
  ...
  ...
</Descriptor>
```

to include an element tagged <dataStoreManagerClassName> and storing a name for a data store manager class useful for reading and writing data to and from a particular persistent data store on behalf of a business object of a particular class. An exemplary create( ) method in the data store manager factory (166) uses Java reflection to find the class name of a referenced business object, looks up in the XML document the class name of an appropriate data store manager, uses Java reflection to create an instance of the data store manager, and returns to the calling broker (158) a reference to the new data store manager.

The example persistence framework of FIG. 2 has a client program entry point at broker (158), implemented as a call at (174) to Broker.processRequest( ). The processRequest( ) method preferably accepts as parameters a reference to a business object and a processing instruction advising the framework what to do with the data in the business object. Examples of processing instructions include instructions to add the data from the business object to a new record in the persistent data store, to update an existing record in the persistent data store to conform with the data values in the business object, to delete from the persistent data store a record identified by data values in the business object, or to execute a query on the persistent data store according to data values in the business object.

The purpose of adapter (156) is to add flexibility to the persistence framework with respect to data communications. The client entry point in the broker (158) at reference (174) is useful when the client program (110) is capable of determining and administering the fact that a broker, mapper, or data store manager may be located locally or remotely with respect to the computer on which the client program is running. As a practical matter, it is desired to offload from the client program the responsibility for such knowledge and decision making, shifting that responsibility to the framework. This may be carried out, for example, by providing a client program entry into the framework at reference (172) with a call to:
Adapter.processRequest(Object someBusinessObject, Instruction ADD).

Adapter (156) then calls a create( ) method in broker factory (162) to obtain a reference to a broker useful with the particular business object. BrokerFactory.create( ) uses Java reflection to find the class name of the referenced business object, looks up in an XML document the class name of an appropriate broker, uses Java reflection to create an instance of the broker, and returns to the calling adapter (156) a reference to the new broker. To support lookups of broker class names based on business object class names, the exemplary XML document described above may be expanded to include broker class names for business objects:

```
<Descriptor>
  <businessObjectClassName> someBusinessObject
    <mapperClassName> simpleMapper
    </mapperClassName>
    <dataStoreMgrClassName> someDSManager
    </dataStoreMgrClassName>
    <brokerClassName> someBroker
    </brokerClassName>
  </businessObjectClassName>
  <businessObjectClassName> someOtherBusinessObject
    <mapperClassName> complexMapper
    </mapperClassName>
    <dataStoreMgrClassName> anotherDSManager
    </datastoreMgrClassName>
    <brokerClassName> anotherBroker
    </brokerClassName>
  </businessObjectClassName>
  ...
  ...
</Descriptor>
```

Readers of skill in the art will have noted that, although moving the client program entry point from the broker (174) to the adapter (172) can offload data communications responsibility from the client program (110), the client program still must be aware of the needs for some form of data communications. Even that responsibility can be removed from the client level by use of framework manager (154). That is, using framework manager (154) in persistence framework (154) serves to insulate calling client programs (110) from any knowledge whether their requests for data processing with respect to business objects are carried out locally or remotely. Framework manager (154) provides a client program entry point into the framework at reference (170) through a call to:
FrameworkManager.processRequest(Object someBusinessObject, Instruction ADD).

Framework manager (154) calls a create( ) method in adapter factory (160) to obtain a reference to an adapter useful with the particular business object. AdapterFactory.create( ) uses Java reflection to find the class name of the referenced business object, looks up in an XML document the class name of an appropriate adapter, uses Java reflection to create an instance of the adapter, and returns to the calling framework manager (154) a reference to the new adapter. To support lookups of adapter class names based on business object class names, the exemplary XML document described above may be expanded to include adapter class names for business objects.

```
<Descriptor>
  <businessObjectClassName> someBusinessObject
    <mapperClassName> simpleMapper
    </mapperClassName>
    <dataStoreMgrClassName> someDSManager
    </dataStoreMgrClassName>
    <brokerClassName> someBroker
    </brokerClassName>
    <adapterClassName> localAdapter
    </adapterClassName>
  </businessObjectClassName>
  <businessObjectClassName> someOtherBusinessObject
    <mapperClassName> complexMapper
    </mapperClassName>
    <dataStoreMgrClassName> anotherDSManager
    </dataStoreMgrClassName>
    <brokerClassName> anotherBroker
    </brokerClassName>
    <adapterClassName> corbaAdapter
    </adapterClassName>
  </businessObjectClassName>
  <businessObjectClassName> yetAnotherBusinessObject
    <mapperClassName> complexMapper
    </mapperClassName>
    <dataStoreMgrClassName> anotherDSManager
    </dataStoreMgrClassName>
    <brokerClassName> anotherBroker
    </brokerClassName>
    <adapterClassName> rmiAdapter
    </adapterClassName>
  </businessObjectClassName>
  ...
  ...
</Descriptor>
```

The example XML document just above provides further explanation of the fact that, as noted at reference (176) on FIG. 2, the association between adapter (156) and broker (158) may be local or remote through an optional network connection, with method calls from the adapter to the broker implemented as local calls or remote procedure calls. The example XML document just above associates with the business object class name “someBusinessObject” an adapter class named “localAdapter,” which is a concrete adapter class designed for use with a broker on the same computer as the adapter. This example XML document associates with the business object class name “someOtherBusinessObject” an adapter class named “corbaAdapter,” which is a concrete adapter class designed to communicate with a remote broker through “CORBA,” the Common Object Request Broker Architecture. This example XML document associates with the business object class name “yetAnotherBusinessObject” an adapter class named “rmiAdapter,” which is a concrete adapter class designed to communicate with a remote broker through Java Remote Method Invocation or “RMI.”

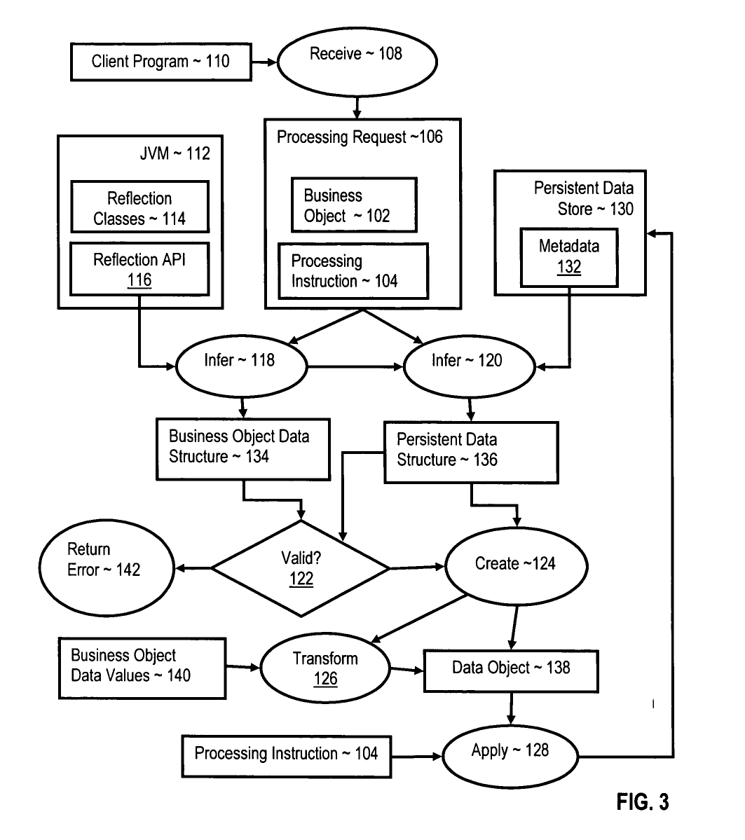

Data processing according to embodiments of the present invention for objects with unknown data structures is further explained with reference to FIG. 3. FIG. 3 sets forth a data flow diagram illustrating an exemplary method of data processing for objects with unknown data structures that includes receiving (108) a processing request (106) for a business object (102) having an unknown business object data structure. In the example of FIG. 3, data for the business object is stored in a persistent data store (130) having an unknown persistent data structure, and the processing request (106) includes a reference (102) to the business object and a processing instruction (104).

In terms of the exemplary persistence framework of FIG. 2, a processing request may be embodied as a processRequest( ) call to a framework manager (154), or as a separate object containing references to a business object and a processing instruction, or otherwise as will occur to those of skill in the art. In addition, it is useful for explanation to note that in the following discussion of the example method of FIG. 3, the steps of inferring (118) the business object data structure (134), inferring (120) the persistent data structure (136), validating (122) the business object data structure (134), creating (124) a data object (138), and transforming (126) data values (140) may be carried out primarily through member methods in a mapper like that shown at reference (150) on FIGS. 1 and 2.

The processing instruction may be any instruction for data processing that can be executed against a persistent data store. A persistent data store can be any non-volatile store of computer data described by metadata. A common example of a persistent data store is a database operated through a database management system with its data structures described in a data dictionary. Another example of a persistent data store is a message-oriented middleware system such as, for example, IBM's MQ Series™ of middleware products. In terms of database operations processing instructions may include the following exemplary instructions:
an instruction to add a new record to a database table and populate it with data values from the business object,
an instruction to update an existing record in a database table with data values from the business object,
an instruction to delete an existing record in a database table, where the record to be deleted is identified by use of data values from the business object, and
an instruction to query a database table to return records containing data values that match data values from the business object.

The method of FIG. 3 also includes inferring (118) the business object data structure (134) from metadata (114) describing the business object. Because it is expected to be such a common implementation of embodiments of the present invention, the metadata describing the business object is illustrated in FIG. 3 as Java reflection classes (114) in a Java virtual machine (112) accessed through a standard Java reflection API (116). That is, in the example of FIG. 3, the business object may be a Java object, and inferring the business object data structure from metadata describing the business object may be carried out by calling Java reflection methods in a Java reflection interface or API. In this example, the business object has a class name, and, as described above, inferring the business object data structure from metadata describing the business object typically is accomplished by inferring the business object data structure in dependence upon the class name of the business object.

The method of FIG. 3 also includes inferring (120) the persistent data structure (136) from metadata (132) describing the persistent data structure. In examples according to FIG. 3, a persistent data store may be a table in a database, and inferring the persistent data structure from metadata describing the persistent data structure may be carried out by reading from metadata describing the database—as, for example, calling through a database management API into a data dictionary to obtain descriptions of tables in a database. In embodiments where the persistent data store is a table in a database, inferring the persistent data structure may be carried out by identifying the table in dependence upon a class name of the business object. The business object class may be intentionally given the same name as its corresponding database table. Or the table name may be recorded in a field in the business object dedicated to that purpose. Other ways of identifying the corresponding table name will occur to those of skill in the art, and all such ways are well within the scope of the present invention.

The method of FIG. 3 further includes validating (122) the business object data structure (134) with respect to the persistent data structure (136). Validating the business object data structure with respect to the persistent data structure means determining that all data values in the business object can be mapped to corresponding fields in the persistent data structure. That is, validating the business object data structure with respect to the persistent data structure typically includes determining that there exists a mapping from fields in the business object to fields in the persistent data store.

In simple mappings, validation means checking that all fields in the business object have corresponding fields with the same field name, or with synonymous field names, in the persistent data structure. That is, for simple mappings, there may be a one-to-one correspondence between field names in the business object and field names in the persistent data store, or a simple mapping may be an algorithmically-inferred one-to-one correspondence between fields in the business object and fields in the persistent data store as, for example, synonymous field names defined in as synonyms in a synonym table.

In more complex mappings, validation means checking that the data values for all fields in the business object can be converted from the field name and data type of the business object to the corresponding field name and data type of the persistent data structure. In the method of FIG. 3, if a business object data structure (134) fails validation, the method (142) returns an error, throws an exception, or otherwise indicates to its calling program that a business object has failed validation. The mapping may be a correspondence, defined in a mapping data structure, between fields in the business object and fields in the persistent data store. Such mapping may include descriptions of correspondence between fields having very different names, required conversions among data types, and rules for establishing values for fields having no one-to-one correspondence—as, for example, when one field value is the sum of values from several other fields. To support lookups of rules for complex mappings, the exemplary XML document described above may be expanded to include mapping rules:

```
<Descriptor>
  <businessObjectClassName> someBusinessObject
    <mapperClassName> simpleMapper
    </mapperClassName>
    <dataStoreMgrClassName> someDSManager
    </dataStoreMgrClassName>
    <brokerClassName> someBroker
    </brokerClassName>
    <adapterClassName> someAdapter
    </adapterClassName>
    <mappingRules>
      <rule></rule>
      <rule></rule>
      <rule></rule>
      ...
      ...
    </mappingRules>
  </businessObjectClassName>
  <businessObjectClassName> someOtherBusinessObject
    <mapperClassName> complexMapper
    </mapperClassName>
    <dataStoreMgrClassName> anotherDSManager
    </dataStoreMgrClassName>
    <brokerClassName> anotherBroker
    </brokerClassName>
    <adapterClassName> anotherAdapter
    </adapterClassName>
    <mappingRules>
      <rule></rule>
      <rule></rule>
      <rule></rule>
      ...
      ...
    </mappingRules>
  </businessObjectClassName>
  ...
  ...
</Descriptor>
```

The method of FIG. 3 includes creating (124) a data object (138) structured according to the persistent data structure (136). That a data object (138) is structured according to a persistent data structure (136) does not necessarily mean that the entire structure of the data object is the same as that of the persistent data structure. It does mean, however, that a data object structured according to the persistent data structure at least describes the table names, the field names, and the field values for use in processing of the persistent data store.

The method of FIG. 3 also includes transforming (126) data values (140) from the business object to the data object (138). In this example, transforming (126) data values (140) from the business object to the data object includes transforming the data values according to mappings from fields in the business object to fields in the persistent data store. That is, transforming the data values means mapping or converting all data values in the business object to corresponding fields in a data object. In simple mappings, transformation means mapping all fields in the business object to corresponding fields in a data object associated with the same field name, or with synonymous field names, in the persistent data structure. In more complex mappings, transformation means converting the data values for all fields in the business object from the field name and data type of the business object to the corresponding field name and data type of the data object.

The method of FIG. 3 includes applying (128) the processing instruction (104), with the data object (138), to the persistent data store (130). In terms of the persistence framework of FIG. 2, this is the processing carried out by calls to member methods in the data store manager (152) to add( ), update( ), delete( ), or query( ) data in the persistent data store (130). In database management terms, for example, the apply function (128) typically converts the data values from the data object and the processing instruction into one or more SQL queries that are then applied against the database. The apply function (128) returns indications of success or failure for the processing instructions add( ), update( ), and delete( ). For the processing instruction query( ), the apply function (128) returns one or more data objects bearing data values from one or more database records that satisfy a query. In terms of the persistence framework of FIG. 2 then, data store manager (152) returns to the broker (158) that called its query( ) method a multiplicity of data objects, one for each database record that satisfies the query. The broker then again calls mapper (150), this time for a reverse transformation of the data values from the data object into one or more business objects. The mapper returns a hash table or other data structure containing references to the new business objects, and that new data structure is returned up the call chain eventually all the way to the calling client program (110).

It will be understood from the foregoing description that various modifications and changes may be made, and in fact will be made, in the exemplary embodiments of the present invention without departing from its true spirit. The descriptions in this specification are for purposes of illustration only and are not to be construed in a limiting sense. The scope of the present invention is limited only by the language of the following claims.

1. A method of data processing for objects with unknown data structures, the method comprising:
receiving a processing request for a business object having an unknown business object data structure, wherein
data for the business object is stored in a persistent data store having an unknown persistent data structure, and
the processing request includes a reference to the business object and a processing instruction;
inferring the business object data structure from metadata describing the business object;
inferring the persistent data structure from metadata describing the persistent data structure;
validating the business object data structure with respect to the persistent data structure;
creating a data object structured according to the persistent data structure;
transforming data values from the business object to the data object; and
applying the processing instruction, with the data object, to the persistent data store.

2. The method of claim 1 wherein the business object is a Java object and inferring the business object data structure from metadata describing the business object comprises Java reflection.

3. The method of claim 1 wherein the business object has a class name and inferring the business object data structure from metadata describing the business object comprises inferring the business object data structure in dependence upon the class name of the business object.

4. The method of claim 1 wherein the persistent data store is a table in a database and inferring the persistent data structure from metadata describing the persistent data structure comprises reading from metadata describing the database.

5. The method of claim 1 wherein the persistent data store is a table in a database and inferring the persistent data structure comprises identifying the table in dependence upon a class name of the business object.

6. The method of claim 1 wherein validating the business object data structure with respect to the persistent data structure comprises determining that there exists a mapping from fields in the business object to fields in the persistent data store.

7. The method of claim 6 wherein the mapping comprises a one-to-one correspondence between field names in the business object and field names in the persistent data store.

8. The method of claim 6 wherein the mapping comprises an algorithmically-inferred one-to-one correspondence between fields in the business object and fields in the persistent data store.

9. The method of claim 6 wherein the mapping comprises a correspondence, defined in a mapping data structure, between fields in the business object and fields in the persistent data store.

10. The method of claim 6 wherein transforming data values from the business object to the data object comprises transforming the data values according to the mapping from fields in the business object to fields in the persistent data store.

11. A system for data processing of objects with unknown data structures, the system comprising:
means for receiving a processing request for a business object having an unknown business object data structure, wherein
data for the business object is stored in a persistent data store having an unknown persistent data structure, and
the processing request includes a reference to the business object and a processing instruction;
means for inferring the business object data structure from metadata describing the business object;
means for inferring the persistent data structure from metadata describing the persistent data structure;
means for validating the business object data structure with respect to the persistent data structure;
means for creating a data object structured according to the persistent data structure;
means for transforming data values from the business object to the data object; and
means for applying the processing instruction, with the data object, to the persistent data store.

12. The system of claim 1 1 wherein the business object is a Java object and means for inferring the business object data structure from metadata describing the business object comprises Java reflection.

13. The system of claim 11 wherein the business object has a class name and means for inferring the business object data structure from metadata describing the business object comprises means for inferring the business object data structure in dependence upon the class name of the business object.

14. The system of claim 11 wherein the persistent data store is a table in a database and means for inferring the persistent data structure from metadata describing the persistent data structure comprises means for reading from metadata describing the database.

15. The system of claim 11 wherein the persistent data store is a table in a database and means for inferring the persistent data structure comprises means for identifying the table in dependence upon a class name of the business object.

16. The system of claim 11 wherein means for validating the business object data structure with respect to the persistent data structure comprises means for determining that there exists a mapping from fields in the business object to fields in the persistent data store.

17. The system of claim 16 wherein the mapping comprises a one-to-one correspondence between field names in the business object and field names in the persistent data store.

18. The system of claim 16 wherein the mapping comprises an algorithmically-inferred one-to-one correspondence between fields in the business object and fields in the persistent data store.

19. The system of claim 16 wherein the mapping comprises a correspondence, defined in a mapping data structure, between fields in the business object and fields in the persistent data store.

20. The system of claim 16 wherein means for transforming data values from the business object to the data object comprises means for transforming the data values according to the mapping from fields in the business object to fields in the persistent data store.

21. A computer program product for data processing of objects with unknown data structures, the computer program product comprising:
a recording medium;
means, recorded on the recording medium, for receiving a processing request for a business object having an unknown business object data structure, wherein
data for the business object is stored in a persistent data store having an unknown persistent data structure, and
the processing request includes a reference to the business object and a processing instruction;
means, recorded on the recording medium, for inferring the business object data structure from metadata describing the business object;
means, recorded on the recording medium, for inferring the persistent data structure from metadata describing the persistent data structure;
means, recorded on the recording medium, for validating the business object data structure with respect to the persistent data structure;
means, recorded on the recording medium, for creating a data object structured according to the persistent data structure;
means, recorded on the recording medium, for transforming data values from the business object to the data object; and
means, recorded on the recording medium, for applying the processing instruction, with the data object, to the persistent data store.

22. The computer program product of claim 21 wherein the business object is a Java object and means for inferring the business object data structure from metadata describing the business object comprises Java reflection.

23. The computer program product of claim 21 wherein the business object has a class name and means for inferring the business object data structure from metadata describing the business object comprises means, recorded on the recording medium, for inferring the business object data structure in dependence upon the class name of the business object.

24. The computer program product of claim 21 wherein the persistent data store is a table in a database and means for inferring the persistent data structure from metadata describing the persistent data structure comprises means, recorded on the recording medium, for reading from metadata describing the database.

25. The computer program product of claim 21 wherein the persistent data store is a table in a database and means for inferring the persistent data structure comprises means, recorded on the recording medium, for identifying the table in dependence upon a class name of the business object.

26. The computer program product of claim 21 wherein means for validating the business object data structure with respect to the persistent data structure comprises means, recorded on the recording medium, for determining that there exists a mapping from fields in the business object to fields in the persistent data store.

27. The computer program product of claim 26 wherein the mapping comprises a one-to-one correspondence between field names in the business object and field names in the persistent data store.

28. The computer program product of claim 26 wherein the mapping comprises an algorithmically-inferred one-to-one correspondence between fields in the business object and fields in the persistent data store.

29. The computer program product of claim 26 wherein the mapping comprises a correspondence, defined in a mapping data structure, between fields in the business object and fields in the persistent data store.

30. The computer program product of claim 26 wherein means for transforming data values from the business object to the data object comprises means, recorded on the recording medium, for transforming the data values according to the mapping from fields in the business object to fields in the persistent data store.
